(19) United States
(12) Patent Application Publication
(10) Pub. No.: US 2022/0212164 A1
(43) Pub. Date: Jul. 7, 2022

(54) A method of capturing and analysing microplastic particles from aqueous medium

(71) Applicant: Teknologian tutkimuskeskus VTT Oy, Espoo (FI)

(72) Inventors: Minna Hakalahti, Espoo (FI); Tekla Tammelin, Espoo (FI); Anna-Stiina Jääskeläinen, Espoo (FI); Suvi Arola, Espoo (FI)

(21) Appl. No.: 17/608,496

(22) PCT Filed: Feb. 25, 2020
(86) PCT No.: PCT/FI2020/050120

§ 371 Date: Nov. 3, 2021

(30) Foreign Application Priority Data
May 3, 2019 (FI) 20195359

(51) Int. Cl. B01J 20/24; C08L 97/02; B01J 20/28; B01J 20/34; C02F 1/28

(52) U.S. Cl. CPC B01J 20/24; C08L 97/02; B01J 20/28007; B01J 20/28023; C02F 2101/32; B01J 20/28085; B01J 20/3425; B01J 20/3483; C02F 1/286; B01J 20/28083

(57) ABSTRACT

According to an example aspect of the present invention, there is provided a method of capturing and analyzing of colloidal microplastics and nanoplastics from aqueous medium. More precisely, the invention relates to a method for collecting and analyzing colloidal nano- and microplastic particles from aqueous media using nanoscaled lignocellulosic structures.

### FIELD

The present invention relates to the field of water treatment and analysis, in particular to a method of capturing and analysing microplastics, in particular colloidal microplastic and nanoplastic particles, from aqueous medium. Moreover, the invention relates to a method for capturing and optionally quantifying and/or identifying colloidal regime microplastic particles and nanoplastic particles from aqueous medium using nanoscaled lignocellulosic structures.

### BACKGROUND

Microplastic pollution entering our environment at an increasing rate causes major problems in especially the aquatic environment where microplastics cause health issues and mortality to living creatures. Microplastic particles (μPp) are omnipresent found in even the most remote corners of our planet such as the deep sea. Their reported presence in human food raises now concerns for human health.

Due to their small size, micro- and nanoplastic particles escape current filter systems and finally end up in the oceans in colossal amounts. In the marine environment they have pervasive consequences as they are ingested by marine animals, e.g. fish and crustaceans, and further up the food chain by humans.

Plastic materials are persistent and degrade over hundreds or thousands of years while at the same eroding in the environment to smaller microplastic particles (μPp, size ≥1 μm) and nanoplastic particles (nPp, size <1 μm). To date there are no means to recover nPp from the environment for quantitation or qualitative analysis as the proposed methods for μPp recovery are based on different filtration and elutriation techniques suited only for the larger regime of the μPp, namely 50 μm and above.

Due to limited methods for nPp and smallest μPp extraction from the environment very little is known about their quantities in the environment. Studies showing nPp accumulation in aquatic organisms have been done and clearly show their presence in the environment. By using synthetic plastic particles of size below 1 μm, it has also been shown that the nPp accumulate and effect drastically the quality of life and health of several aquatic organisms.

The current methods for μPp extraction are mainly based on density flotation, migration velocity differences and filtration techniques of plastics from the environment they reside in. For example Coppock et al (2017) disclose a portable method to separate microplastics within a size range of 100 μm to 10 mm from marine sediments of differing types using the principle of density flotation. Also Kedzierski et al (2016) studied marine sediments, using an elutriation column to extract microplastics having a size of 63 μm—2 mm. Bhattacharya et al (2010) studied binding of nanoplastics (55 nm) on the surface of a cellulose film made of microcrystalline powder.

However, the current methods are restricted to the larger regime of the μPp size range, being capable of extracting particles with a diameter in tens of microns and at best some microns. This leaves a blind spot for the quantitation, qualification and removal of smaller μPp (particle size <50 μm, in particular <40 μm or even ≤10 μm) and nPp.

The nPp are considered very harmful to the environment due to their small size (hard to capture, can enter cells), large surface area (capable of binding relatively large amounts of toxins), and colloidal nature (making extraction difficult). As the researchers lack methods to capture the nPp and the smaller μPp it has not been possible to gather profound knowledge on their prevalence or identity in the environment. Some studies have analysed their presence in aquatic animals such as fish and mollusks where they have been found and quantified proving their existence. In the laboratories the researchers have shown that model nPp (PS beads) accumulate on algal cell surfaces, to various organs in mussels and to juvenile zebra fish affecting their quality of life. These results show a clear need for standardized methods to assess the amounts and identity of nPp and small μPp in the environment.

Thus there remains a need for a method of capturing the nPp and the smallest μPp for quantifying their amount in the environment and also for identifying them.

### SUMMARY OF THE INVENTION

The invention is defined by the features of the independent claims. Some specific embodiments are defined in the dependent claims.

The present invention is based on the finding that certain porous, highly hydrophilic and hygroscopic materials act as an efficient capturing agent for the most problematic nPp and even the smallest part of μPp. Such porous materials include nanoscaled lignocellulosic structures, particularly cellulose nanofibrils or nanofibrillated cellulose, nanocrystalline cellulose or cellulose nanocrystals, microfibrillated cellulose, and bacterial nanocellulose, with the ability to form highly hygroscopic networks, the dimensions of which, especially porosity, can be manipulated with water.

The capturing effect of the above mentioned nanocellulose networks is due to water diffusion induced capillary forces as well as amphiphilic nature and large surface area of nanocellulose, enhancing cohesion between the particles and the nanocellulose. When the fine structure of the cellulose network is in nanoscale, the hydrophilicity and hygroscopicity of nanocellulose network and the capillary effect taking place upon sorption of water provide the capturing effect.

In one embodiment, nanocellulose film or cellulose nanofibril sheet is placed in contact with aqueous medium, whereby water is sorbed and microplastic particles are attached to the surface of nanocellulose. The microplastics are reversibly attached to the film or sheet surface and can be released upon drying of the film or sheet.

According to a first aspect of the present invention, there is thus provided a method of capturing and analysing microplastic particles, in particular colloidal microplastic and nanoplastic particles, from aqueous medium wherein nanoscaled lignocellulosic structures are used as a capturing element.

According to a second aspect of the present invention, there is provided the use of nanoscaled lignocellulosic structures for capturing colloidal microplastic and nanoplastic particles from aqueous medium.

Considerable advantages are obtained by the invention. First, the invention provides a novel method, wherein low-cost, efficient, non-toxic and recyclable biomaterial is used for capturing the most common synthetic colloidal microplastics and nanoplastics, such as polyethylene, polypropylene, and polystyrene, from any aqueous medium. Second, said micro- and nanoplastics can be captured at the site of their formation before they are released into sewage systems and finally end up into aquatic environment. In some embodiments of the invention, colloidal microplastics and nanoplastics can be efficiently captured in water purification plants or systems, including desalination and fresh water purification. In particular, the invention provides a novel method to capture microplastics for analytical purposes, particularly for identifying them and for assessing their amounts.

Further features and advantages of the present technology will appear from the following description of some embodiments.

### BRIEF DESCRIPTION OF THE DRAWINGS

FIGS. 1A and 1B illustrate QCM-D adsorption graphs showing frequency (FIG. 1A) and dissipation (FIG. 1B) change due to the attachment of 100 nm non-purified uncharged PS particles on native CNF, TEMPO-oxidized CNF (TEMPO-CNF), polystyrene (PS), trimethyl-silyl cellulose (TMSC), and regenerated cellulose (RC) thin films;

FIGS. 2A and 2B illustrate QCM-D adsorption graphs showing frequency (FIG. 2A) and dissipation (FIG. 2B) change due to the attachment of 1.1 μm non-purified uncharged PS particles on native CNF, TEMPO-oxidized CNF (TEMPO-CNF), polystyrene (PS), trimethyl-silyl cellulose (TMSC), and regenerated cellulose (RC) thin films;

FIG. 3 illustrates entrapment of fluorescently labelled charged nPp and cPp on various self-standing films. FIG. 3a) The experimental setup for quantitative assessment of the films' ability to capture plastic particles. FIG. 3b) Number of entrapped cPp (left) and nPp (right) calculated based on fluorescence detection. The black lines in the graphs represent 25% (graph on the left) and 100% (graph on the right) entrapment from the theoretical maximum amount of particles (full coverage). The numerical data is shown in Table 1.

FIGS. 4A to 4D show SEM images of capturing surfaces after QCM-D studies. FIG. 4A shows SEM image (7.5K× magnification) of CNF thin film on QCM-D quartz crystal with adsorbed uncharged stabilized 100 nm PS particles (nPp), FIG. 4B shows SEM image (7.5K× magnification) of PS thin film on QCM-D quartz crystal with adsorbed uncharged stabilized 100 nm PS particles (nPp), FIG. 4C shows SEM image (500× magnification) of CNF thin film on QCM-D quartz crystal with adsorbed uncharged stabilized 1.0 μm PS particles (cPp), FIG. 4D shows SEM image of the same sample from another spot with 1.0 K× magnification, and FIG. 4E shows SEM image (500× magnification) of PS thin film on QCM-D quartz crystal with adsorbed uncharged stabilized 1.0 μm PS particles (cPp).

FIG. 5A illustrates QCM-D curves and SEM images from adsorption of uncharged nPp on PS and CNF thin films. FIG. 5B shows the calculated number of uncharged nPp adsorbed on QCM-D crystals during the experiment based on SEM images taken after adsorption experiments. The right-hand bars represent the purified PS particles and left-hand bars represent the stabilized PS particles. The two black lines indicate 10% (bottom line) and 30% (top line) of the maximum amount of nPp that could theoretically adsorb if surfaces were fully covered not taking into account surface roughness. The numerical data is shown in Table 2.

### EMBODIMENTS

By general definition, the term “microplastics” or “microplastic particles” comprises particles of common synthetic polymers, with diameters ≤1 mm or even 5 mm. Within the present disclosure, in particular colloidal microplastic particles, i.e. microplastic particles with diameters ≤50 μm, ≤40 μm, ≤30 μm, ≤20 μm, ≤10 μm or ≤1 μm, are of interest.

Correspondingly, the term “nanoplastics” or “nanoplastic particles” by definition refers to particles of common synthetic polymers with diameters of ≤100 nm (≤0.1 μm). Micro- and nanoplastics are released from e.g. cosmetics and synthetic textiles into sewage waters and from marine litter through abrasion.

Common synthetic polymers include but are not limited to polymers such as polyethylene (PE, including LDPE and HDPE), polypropylene (PP), polystyrene (PS), polyesters, such as polyethylene terephthalate (PET); ethylene propylene, polyvinylchloride (PVC), polytetrafluoroethylene (PTFE), polylactic acid (PLA), polycarbonate (PC), acrylic, polyacrylic acid (PAA), acetal, nylon, and acrylonitrile butadiene styrene (ABS).

Within this disclosure, “nanoscaled lignocellulosic structures” include any nanoscaled cellulosic networks, either derived from plant sources or produced by bacteria (bacterial cellulose). Plant-based sources include any lignocellulosic plant-based sources, preferably wood-based sources, more preferably pulped wood-based sources, which can be processed to nanoscaled lignocellulosic structures.

“Nanoscaled cellulose” encompasses cellulose nanofibrils (CNF) or nanofibrillated cellulose (NFC), microfibrillated cellulose (MFC), nanocrystalline cellulose (NCC) or cellulose nanocrystals (CNC), and bacterial nanocellulose. The size of fibers in these materials is typically 2-500 nm in width, preferably 2-50 nm.

Nanoscaled lignocellulosic structures include in particular solid nanocellulose based 1D, 2D or 3D architectures, wherein the fine structure is in nanoscale and which have the ability to form highly hygroscopic networks.

It has been found that nanoscaled cellulose acts as an ideal capturing element for colloidal microplastic particles, including nanoplastic particles, in particular colloidal nanoplastic particles. This is due to an extremely hygroscopic and amphiphilic large reactive surface area of nanoscaled cellulose, which offers large contact area and thus maximal cohesion between fibrils and smallest μPp/nPp. Secondly, the water diffusion induced capillary forces occurring at nanoscaled cellulosic networks have been found sufficient enough to attract colloidal particles. Thirdly, hydrophobic interactions at cellulose fibril surfaces caused by the amphiphilic nature of cellulose enhance cohesion between nanoscaled cellululose and nano- and microplastic particles.

In embodiments, nanoscaled cellulose can be provided in any applicable 1D, 2D, or 3D network architecture, which retains its structure when contacted with water or aqueous medium. The structure of the final purification or capturing unit is not decisive for the capturing ability, which is defined only by the above mentioned features of nanoscaled cellulose (hydgroscopicity, high surface area) and its ability to form networks, which can be 1D, 2D or 3D architectures.

Correspondingly, the capturing mechanism is neither affected by the solid content of the nanoscaled lignocellulosic structures. High solid content nanocellulose grades work as well as low solid-content grades.

The nanoscaled lignocellulosic structures for use in the method of the invention can thus have any 1D, 2D, or 3D network architecture, which retains its structure when contacted with water or aqueous medium.

The nanoscaled lignocellulosic structures for use in the method of the invention are porous materials, wherein the pore size is typically 2-100 nm. However, the pore size is responsive to the presence of aqueous media. Swelling induced by water may cause opening of pores up to micron level.

If desired, in embodiments the nanoscaled lignocellulosic structures can be processed in various ways to yield for example yarns, filament, fibres, films, thin films, self-standing films, sheets, three-dimensional cryogels, aerogels and foams, to name a few. The nanocellulosic network structures of the invention can be prepared using any existing technologies, such as those used for film manufacturing, 3D-printing and foam forming, e.g. 2D structuring via film casting, web forming, or 3D structuring via 3D-printing, foam forming or web forming. For example, methods for preparing CNF films on a support material have been disclosed in WO 2013/060934 A1.

All the above mentioned architectures of nanoscaled lignocellulosic structures, namely 1D, 2D, and 3D, display the advantageous properties of nanoscaled cellulose in capturing colloidal microplastic and nanoplastic particles, namely a) extreme hygroscopic nature that induces capillary forces, b) amphiphilic nature offering hydrophobic and hydrophilic interactions, and c) large reactive surface area enhancing cohesion between the captured material and fibrils.

In an embodiment of the invention, native nanocellulosic networks are used. However, modified forms of nanoscaled cellulose are also applicable, such as functionalized or oxidized CNF, typically trimethylsilyl-functionalized cellulose (TMSC) or TEMPO-oxidized CNF. The hydrophobic film of TMSC adsorbs small quantities of nPp due to the hydrophobic interaction between nPp and the film material. The amphiphilic nature of native cellulose is an advantage in forming stronger cohesion between fibrils and nPp compared for example to the more hydrophilic TEMPO-CNF. By balancing between hydrophobicity and hydrophilicity the adsorption through both capillary forces and hydrophobic interactions can be maximised.

In one embodiment, the nanoscaled lignocellulosic structures comprise solid cellulose nanofibril (CNF) based 1D, 2D, or 3D network architectures, which retain their structure when contacted with water or aqueous medium.

In an embodiment, the invention relates to a method of capturing and analysing, in particular quantifying and/or identifying, microplastic particles from aqueous medium, wherein the microplastic particles comprise plastic particles having a particle size of 0.5 nm to 5000 μm.

In an embodiment, the invention relates to a method of capturing and analysing microplastic particles from aqueous medium, wherein the microplastic particles comprise colloidal microplastic particles having a particle size of ≤50 μm.

In an embodiment, the method of the invention relates to a method of capturing microplastic particles from aqueous medium, wherein the microplastic particles comprise colloidal microplastic particles having a particle size of ≤40 μm, preferably ≤30 μm, ≤20 μm, or 10 μm, more preferably <1 μm.

In an embodiment, the microplastic particles comprise nanoplastic particles having a particle size of ≤100 nm.

In one embodiment, the microplastic particles comprise synthetic polymer particles with a particle size ≤50 μm (μPp) and ≤100 nm (nPp).

The microplastic particles comprise synthetic polymers, particularly synthetic polymers selected from the group consisting of polyethylene, polypropylene, polystyrene, polyethylene terephthalate, polyester, ethylene propylene, polyvinylchloride, polytetrafluoroethylene, polylactic acid, polycarbonate, acrylic, polyacrylic acid, acetal, nylon, and acrylonitrile butadiene styrene, more particularly polyethylene, polypropylene, and polystyrene.

In an embodiment of the invention, the method also comprises the step of releasing the captured microplastic particles, in particular the captured colloidal microplastic and nanoplastic particles, and optional other impurities by drying the nanoscaled lignocellulosic structure. The dried nanoscaled cellulose structure from which said microplastic and nanoplastic particles have been released can be recycled for further use, typically as a microplastic particles capturing element. The amount of said released plastic particles may be assessed and/or the particles may be identified or characterised.

Alternatively, in an embodiment of the invention the nanoscaled cellulose comprising the captured microplastic and nanoplastic particles can be recovered as such, and optionally the amount of captured plastic particles may be assessed and/or the captured plastic particles may be identified or characterised.

In one embodiment of the invention the method of capturing microplastic particles from aqueous medium using nanoscaled cellulose as a capturing element comprises the steps of
providing solid nanocellulose based 1D, 2D, or 3D network architecture, which retains its structure when contacted with aqueous medium;
contacting the solid nanocellulose network with aqueous medium, whereby water is sorbed and colloidal microplastic and nanoplastic particles are reversibly attached to the surface of the solid nanocellulose network; and
optionally releasing the attached plastic particles upon drying the nanocellulose network.

The method of the invention can be applied for capturing colloidal microplastic and nanoplastic particles in any aqueous medium or aqueous environment. Thus the above disclosed nanoscaled lignocellulosic structures are able to capture colloidal microplastic and nanoplastic particles also in the presence of detergents or other ingredients, such as impurities, which might be expected to hinder the capturing effect. This is due to the material performance provided by the highly hygroscopic and large surface area of the nanocellulose based 1D, 2D, or 3D network. For example, large PE particles are very well captured by both native cellulose nanofibrils and modified cellulose nanofibrils, particularly TEMPO-modified CNF cross-linked PVA, despite the presence of a detergent.

In particular, the systems described here elucidate the multitude of interactions governing the adsorption processes involved in the capture of colloidal sized plastic particles with varying surface properties from different environments. In this complex problem, a colloidal natural material offering several types of interactions provides solutions for capturing the most harmful and invisible part of the microplastic problem. Nanocellulose (CNF, NFC), when produced, is a low solid-content hydrogel that can be processed in various ways to yield stabile thin films on supports, self-standing thick films, and three dimensional cryogels and foams, as already mentioned above. All these materials display the advantageous properties of CNF that are key features in capturing nPp and cPp: extreme hygroscopic nature that induces capillary forces, amphiphilic nature offering hydrophobic and hydrophilic interactions, and large reactive surface area enhancing cohesion between the captured material and fibrils. In addition to these crucial properties, CNF materials can be modified in many ways to overcome for example the issues in drying and hornification, and to control properties such as surface chemistry, porosity and density. CNF materials from natural source are also renewable and nontoxic, key aspects when designing next generation materials without fossil-based raw materials.

Correspondingly, the method of the invention can be applied in any aqueous medium or environment, typically water, regardless of whether the medium is in flowing, standing or non-flowing state. The same forces as in flowing medium play a role in capturing microplastic particles in a non-flowing medium where capillary forces also induce the adsorption of larger μPp in addition to nPp. In standing aqueous media, the contact time required for capturing nano- and microplastic particles varies depending on the quality of aqueous medium but is typically within minutes or tens of minutes, yet can be also some hours. In flowing aqueous media, such as discharge water from washing machines or waste water from industrial plants, nano- and microplastic particles are captured continuously during the discharge of waters.

Analysis of the captured microplastic particles may comprise typical analytical techniques such as morphological and physical classification, identification, and quantification of microplastic particles. Assay methods may include for example light scattering techniques, spectroscopic methods such as fluorescent spectroscopy and infrared spectroscopy, direct mass quantification via adsorption (e.g. QCM-D) and various types of imaging techniques (optical microscopy, AFM and SEM) coupled with image analysis.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

### Experimental

In the experiments, synthetic polystyrene latex (PS) beads of two different sizes were used. One was of colloidal sized nPp (100 nm) and the other was at the small end of μPp regime (1.1 μm), to elucidate the effectiveness of capillary forces at colloidal and micro size regime of the materials. Both stabilized particles as provided by the supplier and also purified PS particles washed with the protocol provided by the supplier were used.

Model thin films and self-standing thin films of native CNF, TEMPO-oxidized CNF (TEMPO-CNF), polystyrene (PS), trimethyl-silyl cellulose (TMSC), and regenerated cellulose (RC) were used for adsorption of nPp and μPp. The different thin films were used to elucidate different properties governing the adsorption process.

QCM-D Studies

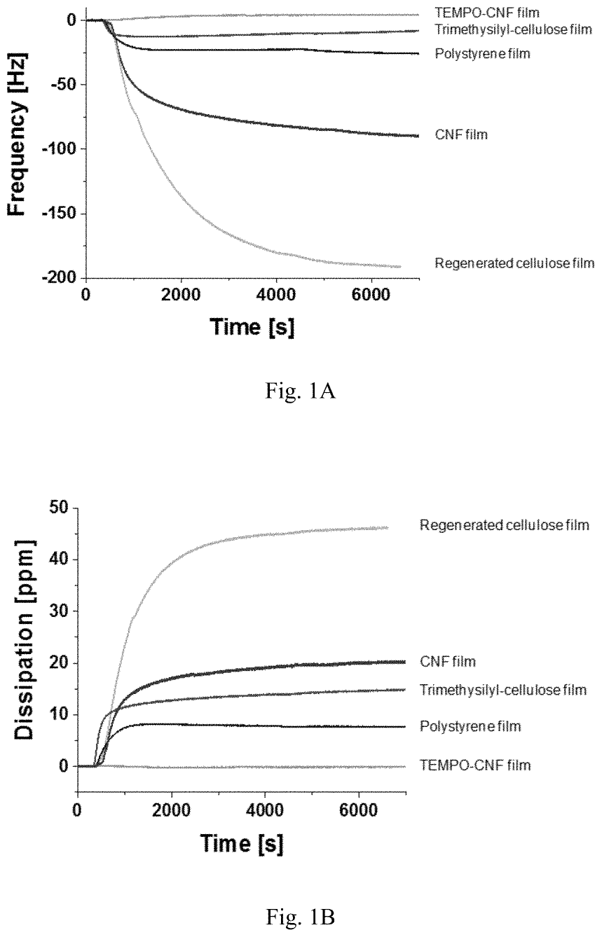

The adsorption of nPp and μPp was studied with a surface sensitive quartz crystal microbalance with dissipation (QCM-D). QCM-D is very sensitive for surface interactions, i.e. adsorption due to for example cohesion. Frequency and dissipation of a quartz crystal were measured (FIGS. 1A and 1B respectively). A negative change in frequency shows adsorption, while a positive change in dissipation shows an increase in elasticity of the surface film (i.e. the film becomes thicker and more water is bound). A thin and rigid film shows lower dissipation values.

Adsorption of nPp: From FIGS. 1A and 1B it is evident that 100 nm non-purified polystyrene particles adsorb on a very thin layer of cellulose nanofibrils from a flowing media efficiently with surface forces. The data in FIGS. 1A and 1B demonstrates cohesion between cellulose nanofibrils (CNF) and PS particles. Amphiphilicity of cellulose offers hydrophobic sites of adhesion for PS particles and at the same time CNF creates capillary forces by water adsorption and transport. The particles do not come off when the film is washed with buffer, since cohesion forces in solution state are strong enough to keep PS particles attached.

Regenerated cellulose (RC) also offers similar sites of adhesion/cohesion. The mass of RC is greater on the QCM-D chip compared to CNF and so the film is thicker. Due to thicker film, more water is transported into it, and thus more PS particles bind, meaning that the RC film swells in water more than CNF.

TEMPO-CNF is more hygroscopic and hydrophilic than the other films and does not have as much of the amphiphilic nature of cellulose as CNF and RC. Therefore, binding of PS particles with surface interactions is greatly affected and no evident binding of PS particles through cohesion/adhesion is seen.

Trimethylsilyl cellulose (TMSC) is a chemically modified regenerated cellulose that is more hydrophobic than the other cellulose films. It swells in water less and binds less water (less capillary forces) compared to CNF, RC, and TEMPO-CNF, showing that its hydrophobicity alone is not enough to bind PS nanoparticles in a sufficient manner.

Polystyrene (PS) should bind PS particles; however, the nanoparticles are not sufficiently meeting the surface in flow as gravitation is not pulling them into contact with surface nor is the film capable of adsorbing water. As water is not transported into the film, there is no capillary flow that can bring the PS particles into contact with the surface and so binding of PS particles with PS film is lower than with CNF, RC, and TMSC.

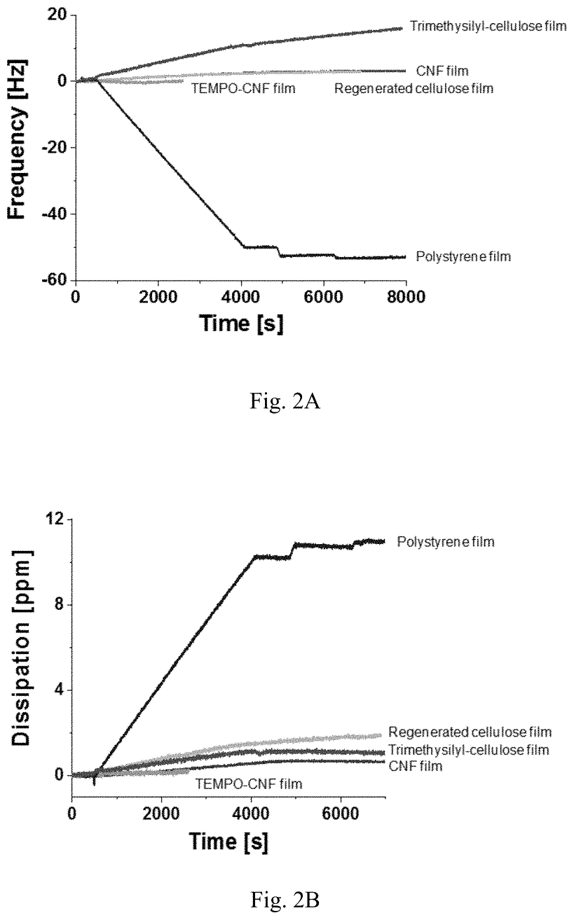

Adsorption of Pp: The QCM-D frequency and dissipation results for 1.0 μm PS particles are shown in FIGS. 2A and 2B, respectively. From the figures, it can be seen that flow forces and gravitation/sedimentation affect the 1.0 μm PS particles that are just beyond the colloidal range in size more than the 100 nm particles, leading to less binding compared to 100 nm particles. The particle size is also large for a surface sensitive method and starts to be at the limit of reliable detections. The PS film seems to gather the particles. The results confirm that surface interactions play a role when dealing with nanosized objects and colloidal range particles.

Quantitative Assessment of Particle Entrapments Using Fluorescence Experiments with Self-Standing Films

Due to their larger size the QCM-D did not show very well the capture of μPp from flow by CNF or other control surfaces (FIGS. 2A and 2B). However, μPp can be captured from a standing solution due to hygroscopic and amphiphilic nature of cellulose and enhanced cohesion due to the large surface area of the CNF network. In the following study fluorescence particles provided by the manufacturer were used for the detection of particles in a solution in a quantitative manner. The modification induced a charge on the particles. Both negatively and positively charged particles were used.

We used fluorescently labelled PS particles of 100 nm and 1.0 μm in size and studied their adsorption to self-standing films of CNF, TEMPO-CNF, RC, TMSC, and PS. The decrease in fluorescence was observed with a fluorescence spectrometer after incubation of film in a known amount of particles and the amount of adsorbed particle was calculated from the difference of before incubation and after incubation. The release of particles was checked with washing the films in buffer and observing the fluorescence in the wash solution after film removal.

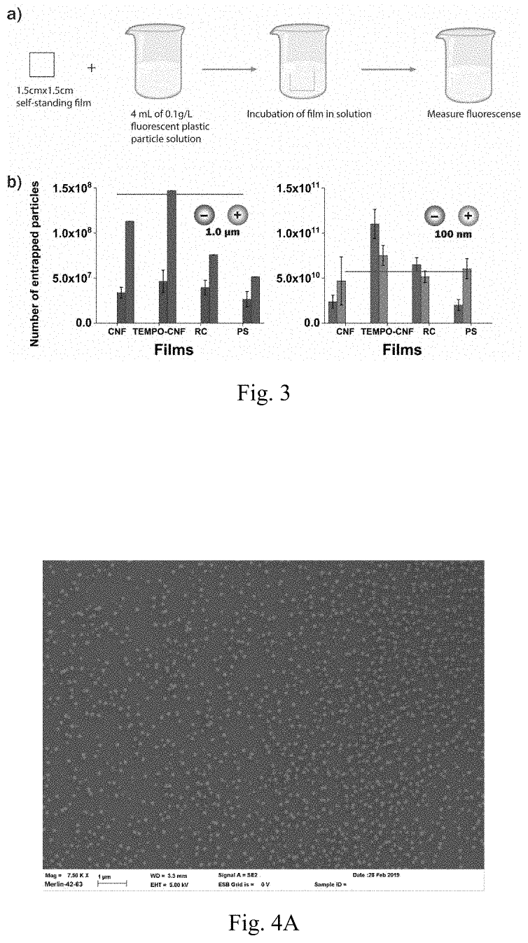

1.5 cm×1.5 cm sized pieces of the above-mentioned films were placed in a beaker containing 4 ml of PS solution with a concentration of 0.1 mg/ml (1.0 μm or 0.1 μm PS solution in 10 μmM phosphate buffer pH 6.8). After 10 minutes fluorescence samples were taken, the films were washed with 10 mM phosphate buffer pH 6.8 and another set of fluorescence samples was taken from the wash solution (FIG. 3a). The results before washing are shown in FIG. 3b for 0.1 μm PS particles and 1.0 μm PS particles.

From the results shown in FIG. 3b and table 1 it can be seen that while all films captured both 100 nm and 1.0 μm particles of both charges, it is evident that the nPp are captured more efficiently than the cPp and positively charged cPp are captured more effectively than negatively charged ones. This indicates that charge plays a role in the capture process of colloids especially when the capturing material is a colloid as well (CNF and TEMPO-CNF). The results in FIG. 3b, right side graph, show that hygroscopic, highly negatively charged, large surface area TEMPO-CNF captures almost 200% of the negatively charged nPp that theoretically could be captured by a two dimensional film if the film was fully covered by the particles. The same material captures approximately 130% of the positively charged nPp. This could be explained by the ability of the negatively charged nPp to penetrate further in to the film structure than the positive nPp as the positive particles interact stronger with the fibril network and stay on the surface. The stronger interactions hinder the positive nPp penetration in to the film structure. The fact that self-standing TEMPO-CNF film can trap more than the theoretical amount of nPp could be caused by the large surface area and the material's hygroscopic nature. The TEMPO-CNF film, once dipped in solution swells in large extent. The swelling induces capillary flow in the film that is strong enough to transport nPp into film network. This capillary flow does not affect the cPp and the entrapment of cPp is mostly governed by charge interactions rather than capillary flow and charge. Generally, the cellulose based materials performed better than polystyrene. TEMPO-CNF was the most hygroscopic of the materials and this water uptake seemed to affect the performance the most. The power of capillary forces was demonstrated by the fact that the negatively charged 100 nm particles were captured the best although TEMPO-CNF is negatively charged. Moreover, the charge seemed to play a role in the bigger particles as positively charged 1.0 μm particles were captured more efficiently than negatively charged.

TABLE 1
Number of charged PS particles entrapped by self-
standing films compared to the theoretical maximum
number that can be entrapped in two dimensions.

| | | | % of |
|---|---|---|---|
| | | | theoretical |
| Surface | PS particles | # of Particles/film | maximum |
| CNF | 1.0 um cationic | 1.13E+08 ± 1.32E+07 | 19.7 |
| | 1.0 um anionic | 3.88E+0.7 ± 5.98E+06 | 6.8 |
| | 0.1 um cationic | 4.68E+10 ± 2.67E+10 | 81.6 |
| | 0.1 um anionic | 2.38E+10 ± 7.23E+09 | 41.5 |
| TEMPO- | 1.0 um cationic | 1.47E+08 ± 1.77E+07 | 25.7 |
| CNF | 1.0 um anionic | 4.63E+07 ± 1.25E+07 | 8.1 |
| | 0.1 um cationic | 7.50E+10 ± 1.12E+10 | 130.8 |
| | 0.1 um anionic | 1.10E+11 ± 1.62E+10 | 192.5 |
| Polystyrene | 1.0 um cationic | 5.15E+07 ± 4.47E+06 | 9 |
| | 1.0 um anionic | 2.65E+07 ± 8.56E+06 | 4.6 |
| | 0.1 um cationic | 6.03E+10 ± 1.12E+10 | 105.2 |
| | 0.1 um anionic | 2.01E+10 ± 6.17E+09 | 35 |
| Regenerated | 1.0 um cationic | 7.58E+07 ± 3.07E+07 | 13.2 |
| Cellulose | 1.0 um anionic | 3.94E+07 ± 8.11E+06 | 6.9 |
| | 0.1 um cationic | 5.15E+10 ± 6.45E+09 | 89.8 |
| | 0.1 um anionic | 6.50E+10 ± 7.71E+09 | 113.4 |

Different sized particles could also be captured from the same solution (data not shown).

The intensity decrease due to wash is shown in Table 2 below.

TABLE 2
The intensity decrease due to wash
in % (wash intensity/intensity_{ads})

| | 0.1 μm(−) | 0.1μm(+) | 1.0 μm(−) | 1.0 μm(+) |
|---|---|---|---|---|
| Film | L9902 | L9904 | L4655 | L9654 |
| CNF | 57.7% | 35.8% | 69.5% | 4.5% |
| TEMPO-PVA | 6.0% | 26.5% | 23.4% | 3.1% |
| reg. CNF | 3.9% | 5.1% | 28.7% | 8.0% |
| PS | 6.9% | 2.9% | 17.3% | 12.5% |

From the wash experiments, we can see that particles of both size and charge were released from all materials tested. The CNF film is able to release approximately 35-60% of the 100 nm particles depending on the charge: more of the negatively charged particles than positively charged ones. PS surface releases more of the 1.1 μm PS particles and less of the 100 nm particles regardless of their charge. RC film in general releases less of the particles of both sizes but most of the negatively charged 1.1 μm particles. TEMPO-CNF-PVA film releases more of the 100 nm positively charged particles and 1.1 μm negatively charged particles, which indicates that the charge does not play a significant role in the capturing and binding of the colloidal 100 nm particles. Yet, charge starts to play a role in binding larger objects.

From the fluorescence data and the wash experiments it can be concluded that the size and charge of the PS particle and the material used for its capture has an effect on the release profile. Particularly, CNF releases all other particles to a large extent except the positively charged 1.1 μm particles. TEMPO-CNF-PVA films release the positively charged 100 nm particles and negatively charged 1.1 μm particles. Regenerated cellulose releases some 25% of the negatively charged larger PS particles but not so much the other particles. Polystyrene seems to attach the 100 nm particles tightly and release between 10-20% of the larger particles. Therefore, by tuning the material properties we can affect and control the release profile.

In the presence of a detergent both CNF and TEMPO-CNF-PVA films are able to capture some 56-58% of the 100 nm and some 7-8% of (data not shown) 1.0 μm PS particles that theoretically can be captured compared to 80-130% and 20-26% (Table 1) without detergent respectively, which is surprising as detergents are known to bind on the CNF surface.

Quantitation of Adsorbed Microplastic Particles on the Thin Films

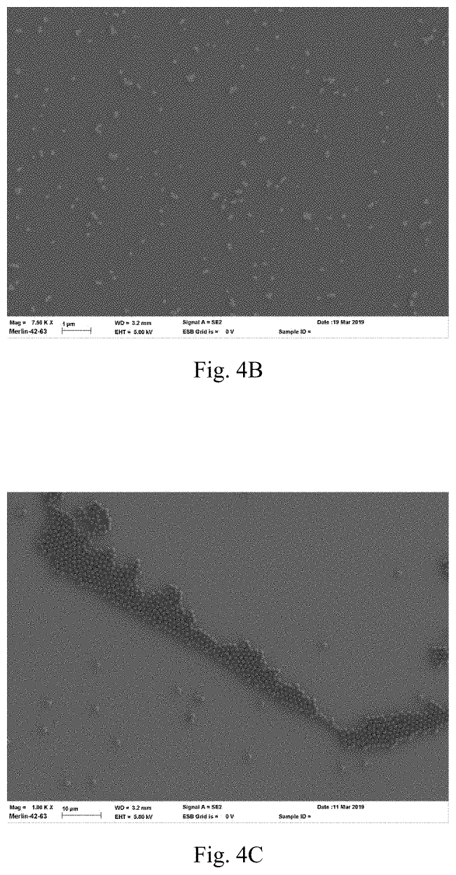

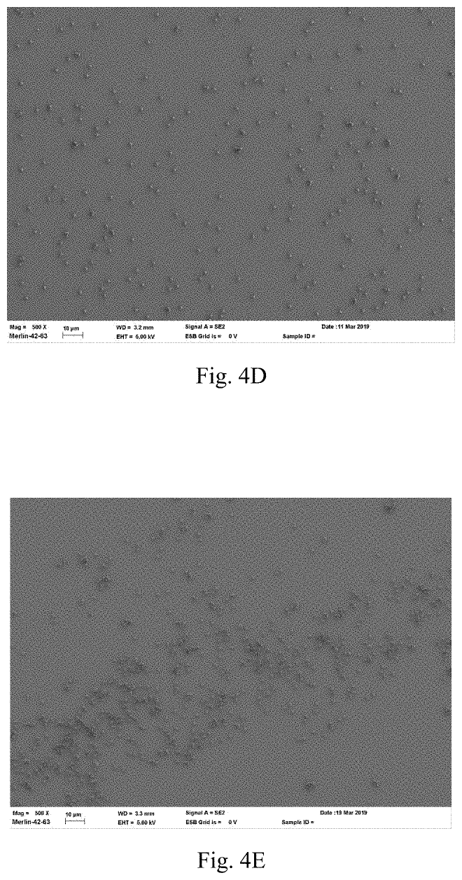

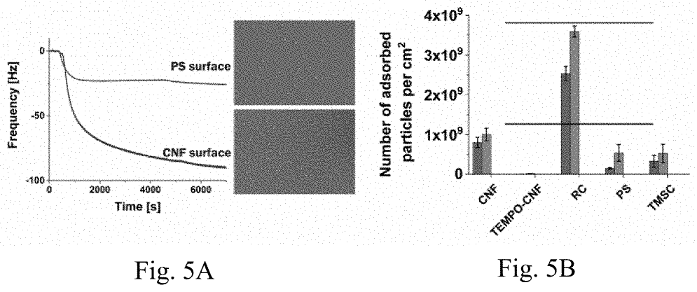

To quantitatively determine the adsorbed amount of polystyrene nanoplastic and colloidal microplastic particles on the surface of the thin films, QCM-D crystals were imaged after the adsorption measurements. SEM images are shown as FIG. 4A (100 nm PS on CNF film), FIG. 4B (100 nm PS on PS film), FIG. 4C and D (1.0 μm PS on CNF film), FIG. 4E (1.0 μm PS on PS film). Images have been taken from the QCM-D chips on which the QCM-D experiments were done. Further, analysis of particle amounts from several SEM images by using Matlab software is given in Table 2 below.

TABLE 3
Number of non-charged PS particles adsorbed on thin-
films compared to the theoretical maximum number that
can adsorb on the surface. Amount of particles calculated
from SEM images using Matlab software.

| | | | % of |
|---|---|---|---|
| | | | theoretical |
| Surface | PS particles | # of Particles/cm2 | maximum |
| CNF | 1.1 um purif. | 1.00E+05 ± 1.30+E05 | 0.1 |
| | 1.1 um non-purif. | 4.00E+05 ± 2.50+E05 | 0.38 |
| | 0.1 um purif. | 1.00E+09 ± 1.60E+08 | 7.85 |
| | 0.1 um non-purif. | 8.00E+08 ± 1.30E+08 | 6.28 |
| TEMPO- | 1.1 um purif. | 2.80E+04 ± 310E+04 | 0.03 |
| CNF | 1.1 um non-purif. | 1.50E+05 ± 1.30E+06 | 0.14 |
| | 0.1 um purif. | 1.70E+07 ± 1.50E+06 | 0.13 |
| | 0.1 um non-purif. | 1.30E+06 ± 8.70E+05 | 0.01 |
| Trimethyl | 1.1 um purif. | 3.00E+05 ± 3.00E+05 | 0.29 |
| silylcellulose | 1.1 um non-purif. | 3.00E+05 ± 2.00E+05 | 0.29 |
| | 0.1 um purif. | 5.30E+08 ± 2.30E+08 | 4.16 |
| | 0.1 um non-purif. | 3.30E+08 ± 1.50E+08 | 2.59 |
| Polystyrene | 1.1 um purif. | 2.00E+06 ± 1.00E+06 | 1.9 |
| | 1.1 um non-purif. | 4.00E+06 ± 4.40E+06 | 3.8 |
| | 0.1 um purif. | 5.40E+08 ± 2.10E+08 | 4.24 |
| | 0.1 um non-purif. | 1.50E+08 ± 1.60E+07 | 1.18 |
| Regenerated | 1.1 um purif. | 1.00E+05 ± 5.00E+04 | 0.1 |
| Cellulose | 1.1 um non-purif. | 1.00E+05 ± 3.00E+04 | 0.1 |
| | 0.1 um purif. | 3.59E+09 ± 1.40E+08 | 28.2 |
| | 0.1 um non-purif. | 2.53E+09 ± 1.80E+08 | 19.9 |

Several things are evident from SEM image analysis. 1) CNF thin films adsorb 100 nm PS particles regardless of whether they are purified or not. RC is the most efficient in capturing the 100 nm particles however; the RC film is much thicker (Table 4 shows results for mass analysis of CNF and RC thin films) than the CNF film and the particle are more agglomerated in the RC films than in the CNF films. Agglomeration indicates cohesion between PS particles in addition to interactions with the capturing film. PS and TMSC thin films adsorb the purified 100 nm particles more than the non-purified ones indicating that the interaction is dictated by hydrophobic interactions not capillary forces due to water uptake. In general, TEMPO-CNF thin films do not adsorb the 100 nm particles very well. This shows that water-binding capacity alone is not enough for particle uptake and some amphiphilic nature is necessary. All materials perform poorly in capturing both purified and non-purified 1.1 μm particles. This indicates that the flow is a significant force in carrying the larger particles by the surface and that the capillary forces are not strong enough to attract them where as it is the opposite for the small colloidal particles.

TABLE 4
QCM-D results on the masses of CNF and RC on thin films.

| Film | Mass (ng/cm²) | Thickness (nm) |
|---|---|---|
| CNF | 311 | 2.3 |
| Regenerated cellulose | 2957 | 24.7 |

The above experiments show that nanocellulosic networks, in particular solid nanocellulose based 1D, 2D, or 3D architectures, provide an efficient means to recover nanoplastic particles and colloidal microplastic particles from the environment for explicit quantification or for qualitative analysis.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in water purification or treatment, including desalination and fresh water purification or treatment. Moreover, some embodiments of the invention find application in water analytics, in particular in identifying nano- and microplastics and assessing their amounts. In some embodiments, the method of the present invention is applied before the microplastics containing water is released to sewage system or environment, for example at factories handling plastic materials or in washing machines at households or laundries.

### ACRONYMS LIST

ABS acrylonitrile butadiene styrene
CNC cellulose nanocrystals
CNF cellulose nanofibrils
cPp colloidal plastic particles
HDPE high density polyethylene
LDPE low density polyethylene
μPp microplastic particles
NCC nanocrystalline cellulose
NFC nanofibrillated cellulose
nPp nanoplastic particles
PAA polyacrylic acid
PC polycarbonate
PE polyethylene
PET polyethylene terephthalate
PLA polylactic acid
PP polypropylene
PS polystyrene
PTFE polytetrafluoroethylene
PVC polyvinylchloride
QCM-D quartz crystal microbalance with dissipation
RC regenerated cellulose
TEMPO-CNF (2,2,6,6-Tetramethylpiperidin-1-yl)oxyl oxidized CNF
TEMPO-CNF-PVA polyvinyl alcohol cross-linked TEMPO-CNF film
TMSC trimethyl-silyl cellulose

### CITATION LIST

### Patent Literature

WO 2013/060934 A1

### Non Patent Literature

Bhattacharya, P. et al, Binding of nanoplastics onto a cellulose film. In: International Nanoelectronic Conference (INEC), 3^{rd}, Edited by Piscataway, N.J., USA: 2010-01-03, 803-804.
Coppock, R. L. et al, A small-scale, portable method for extracting microplastics from marine sediments. Environmental Pollution 230 (2017) 829-837.
Kedzierski, M. et al, Microplastics elutriation from sandy sediments: A granulometric approach. Marine Pollution Bulletin 107 (2016) 315-323.

1. A method of capturing and analyzing microplastic particles from an aqueous medium comprising capturing the microplastic particles with nanoscaled lignocellulosic structures.

2. The method according to claim 1, wherein the nanoscaled lignocellulosic structures comprise a nanocellulosic network.

3. The method according to claim 1, wherein the nanoscaled lignocellulosic structures retain their structure when contacted with aqueous medium.

4. The method according to claim 1, wherein the nanoscaled lignocellulosic structures comprise cellulose nanofibrils (CNF) or nanofibrillated cellulose (NFC), microfibrillated cellulose (MFC), nanocrystalline cellulose (NCC), cellulose nanocrystals (CNC), or bacterial nanocellulose.

5. The method according to claim 1, wherein the nanoscaled lignocellosic structures comprise native or modified forms of cellulose nanofibrils or nanofibrillated cellulose, microfibrillated cellulose, nanocrystalline cellulose, cellulose nanocrystals, or bacterial nanocellulose.

6. The method according to claim 5, wherein the modified forms comprise functionalized or oxidized forms of cellulose nanofibrils or nanofibrillated cellulose, microfibrillated cellulose, nanocrystalline cellulose, cellulose nanocrystals, or bacterial nanocellulose.

7. The method according to claim 1, wherein the microplastic particles comprise plastic particles having a particle size of 0.5 nm to 5000 μm.

8. The method according to claim 1, wherein the microplastic particles comprise colloidal microplastic particles having a particle size of ≤50 μm.

9. The method according to claim 1, wherein the microplastic particles comprise colloidal microplastic particles having a particle size of ≤40 μm.

10. The method according to claim 1, wherein the microplastic particles comprise nanoplastic particles having a particle size of ≤100 nm.

11. The method according to claim 1, wherein the microplastic particles comprise synthetic polymers selected from the group consisting of polyethylene, polypropylene, polystyrene, polyesters, polyethylene terephthalate, ethylene propylene, polyvinylchloride, polytetrafluoroethylene, polylactic acid, polycarbonate, acrylic, polyacrylic acid, acetal, nylon, and acrylonitrile butadiene styrene.

12. The method according to claim 1, wherein the method comprises the steps of:
providing solid nanocellulose based 1D, 2D, or 3D network architectures which retain their structure when contacted with aqueous medium;
contacting the solid nanocellulose network architectures with aqueous medium, whereby water is sorbed and colloidal microplastic and nanoplastic particles are reversibly attached to the surface of the solid nanocellulose networks; and
optionally releasing the attached microplastic particles upon drying the solid nanocellulose networks.

13. The method according to claim 1, wherein the method further comprises the step of releasing the captured microplastic particles by drying the nanoscaled lignocellulosic structures, —and optionally recycling the nanoscaled lignocellulosic structures for further use as a microplastic particles capturing element.

14. The method according to claim 1, wherein the method further comprises the step of recovering the nanoscaled lignocellulosic structures, which contain the captured microplastic particles, as such, and optionally quantifying the amount of said microplastic particles, identifying the captured microplastic particles, or both.

15. The method according to claim 1, wherein the nanoscaled lignocellulosic structures have a pore size of 2-100 nm.

16. The method according to claim 1, wherein the method further comprises the step of analyzing the captured microplastic particles by quantifying their amounts, by identifying or characterizing their type, or both.

17. The method according to claim 16, wherein the step of analyzing the captured plastic particles comprises at least one assay method selected from the group consisting of light scattering techniques, spectroscopic, direct mass quantification via adsorption, and an imaging technique coupled with image analysis.

18-20. (canceled)

21. The method according to claim 1, wherein the microplastic particles comprise colloidal microplastic particles having a particle size of ≤10 μm.

22. The method according to claim 1, wherein the microplastic particles comprise colloidal microplastic particles having a particle size of <1 μm.

23. The method according to claim 1, wherein the nanoscaled lignocellulosic structures comprise solid nanocellulose-based 3D network architectures which retain their structure when contacted with aqueous medium.
